(19) United States
(12) Patent Application Publication
(10) Pub. No.: US 2017/0314274 A1
(43) Pub. Date: Nov. 2, 2017

(54) DRYWALL TRIM PIECE OR TAPE ATTACHED WITH HEATED ADHESIVE

(71) Applicant: UNITED STATES GYPSUM COMPANY, Chicago, IL (US)

(72) Inventors: Guy Rosenthal, Wheaton, IL (US); Salvatore Immordino, Trevor, WI (US)

(21) Appl. No.: 15/434,980

(22) Filed: Feb. 16, 2017

Related U.S. Application Data
(60) Provisional application No. 62/345,480, filed on Jun. 3, 2016.
(60) Provisional application No. 62/328,383, filed on Apr. 27, 2016.

(51) Int. Cl. E04F 19/02; E04F 21/165; E04F 13/073; C09J 5/06; E04F 13/077; E04F 13/24

(52) U.S. Cl. CPC E04F 19/028; E04F 13/24; E04F 21/1655; E04F 21/1652; C09J 5/06; E04F 13/077; E04F 13/0733; E04F 2290/044

(57) ABSTRACT

A trim strip assembly is provided for use on a corner formed by at least two sheets of drywall. The trim strip assembly includes a trim strip body extending along a body axis that may extend longitudinally, and the trim strip body may have at least one inside surface 18. The trim strip assembly also includes an adhesive layer formed over at least a portion of the at least one inside surface of the trim strip body, the adhesive layer having a softening point range such that when the adhesive layer is heated to a temperature within the softening point range, the adhesive layer bonds to at least one of the at least two sheets of drywall to secure the trim strip body to the at least one of the at least two sheets of drywall.

### CROSS REFERENCE TO RELATED APPLICATIONS

The priority benefit of U.S. Provisional Application No. 62/328,383, filed on Apr. 27, 2016, and U.S. Provisional Application No. 62/345,480, filed Jun. 3, 2016, is claimed and the entire contents of each are expressly incorporated herein by reference.

### FIELD OF THE DISCLOSURE

This disclosure relates generally to a trim strip for protecting a corner formed by at least two sheets of drywall.

### BACKGROUND

During the construction process, a trim strip (also referred to as a “corner bead”) is often used when finishing drywall (i.e., gypsum wallboard). This trim strip is typically a length of rigid or semi-rigid material that covers exposed drywall at a corner junction to protect the corner and to provide a finished and clean appearance to the corner. Generally, any corner where two sheets of drywall meet to form an angle less than 180 degrees may be protected with trim strip, and in most applications, the corner angle is usually approximately 90 degrees.

The trim strips, once formed, can be attached over a desired corner via mechanical fasteners, using adhesives, and/or using drywall joint compound. Mechanical fasteners such as screws can be inserted through apertures formed along both side walls of the trim strip and then anchored to the drywall to secure the trim strip over the corner. The joint compound, in paste form, is then applied over the trim strip and the mechanical fasteners. When dry, the resulting joint compound has a smooth finish that can be subsequently sanded and painted.

Trim strips attached with mechanical fasteners make finishing processes such as sanding more difficult, and also make the trim strips prone to edge cracking of the joint compound. Additionally, the use of joint compound requires a substantial drying time. For example, if a backing paper is used, the joint compound generally requires a drying time of at least twelve hours, during which time no corner finishing or painting may occur.

When using joint compound, backing paper (also referred to as “wings”) may be coupled to the trim strip to improve the bond with the joint compound to aid in attachment and in durability of the finished corner. The backing paper is typically secured to a surface of the trim strip using an adhesive, and the trim strip may be positioned on the corner so the backing paper is disposed on the outside (i.e., the trim strip is disposed between the drywall and the backing paper).

For corners that may be subject to impact, plastic trim strips are commonly used. These trim strips are typically made of a polymer that is shaped to a desired angle and cross-sectional geometry. The bulk trim strips then are cut into desired lengths or “sticks” that correspond to the interior height of the wall. Some existing products are constructed from flexible plastics, in strip form, that can be adjusted to various angles. These products are generally manufactured for use in smaller batches. However, in these products, the plastic remains flexible, (i.e., not rigid), and it cannot be permanently formed into many desired cross-sectional shapes (such as bullnose curves) when cooled.

### SUMMARY

A formable trim strip for use on a corner of at least two sheets of drywall includes a trim strip body extending along a body axis and having a top or inside surface and a bottom surface. The trim strip body is formed from a polymer material having a melting point range between about 250° F. and about 400° F. The multi-layer formable trim strip also includes a backing paper, and a portion of this backing paper is secured to the bottom surface of the trim strip body. The backing paper is not secured to the bottom surface of the trim strip body by an adhesive. Rather, the trim strip body is deposited onto the portion of the backing paper when a temperature of the trim strip body is within the melting point range such that the bottom surface of the trim strip body contacts the portion of the backing paper. As the trim strip body cools to a temperature below the melting point range, the portion of the backing paper bonds to the bottom surface of the trim strip body.

A method of forming a multi-layer formable trim strip for use on a corner of at least two sheets of drywall that includes heating a polymer material having a melting point range between about 250° F. and about 400° F. to a temperature between the melting point range. The method also includes advancing a backing paper positioned proximal to the polymer material, and depositing the polymer material onto a portion of the backing paper to form a trim strip body having a top surface and a bottom surface, whereby the bottom surface is in contact with the backing paper. The method further includes allowing the trim strip body to cool (or cooling the trim strip body) to a temperature below the melting point range such that the portion of the backing paper bonds to the bottom surface of the trim strip body.

An assembly for forming a formable trim strip for use on a corner of two sheets of drywall includes a formable trim strip having a trim strip body that has a top surface and a bottom surface, the trim strip body extending along a body axis and having a first cross-sectional shape normal to the body axis. The assembly also includes a die having a first aperture that has a second cross-sectional shape that is different than the first cross-sectional shape of the trim strip. The first aperture is adapted to movably receive the formable trim strip such that the trim strip body of is changed from having the first cross-sectional shape to a cross-sectional shape that corresponds to the second cross-sectional shape as the formable trim strip is displaced through the first aperture.

A trim strip assembly is provided for use on a corner formed by at least two sheets of drywall. The trim strip assembly includes a trim strip body extending along a body axis that may extend longitudinally, and the trim strip body may have at least one inside surface 18. The trim strip assembly also includes an adhesive layer formed over at least a portion of the at least one inside surface of the trim strip body, the adhesive layer having a softening point range such that when the adhesive layer is heated to a temperature within the softening point range, the adhesive layer bonds to at least one of the at least two sheets of drywall to secure the trim strip body to the at least one of the at least two sheets of drywall.

A trim strip assembly is provided for use on a corner of at least two sheets of drywall, the trim strip assembly including a trim strip body extending along a body axis and having at least one inside surface and at least one outside surface. The trim strip body comprises an adhesive material having a softening point range, wherein when the trim strip body is heated to a temperature within the softening point range, at least a portion of the inside surface of the trim strip body bonds to at least one of the at least two sheets of drywall to secure the trim strip body to the at least one of the at least two sheets of drywall.

An application tool is provided for securing a trim strip assembly on a corner of at least two sheets of drywall, the trim strip assembly including a trim strip body having a first side wall and a second side wall and a heat activated adhesive layer formed over at least a portion of an inside surface of the first side wall and an inside surface of the second side wall. The application tool includes a base member having a first base wall and a second base wall, the first base wall having an inside surface and an outside surface and the second base wall having an inside surface and an outside surface, the base member extending parallel to a base axis from a first end to a second end. The application tool also includes a first heating member coupled to the inside surface of the first base wall of the base member and a second heating member coupled to the inside surface of the second base wall of the base member. When the application tool is positioned along the trim strip assembly such that an outer surface of the first heating member is disposed in contact with or adjacent to a portion of the outside surface of the first side wall of the trim strip body and an outer surface of the second heating member is disposed in contact with or adjacent to a portion of the outside surface of the second side wall of the trim strip body, (a) heat generated by the first heating member is adapted to be transferred through the first side wall of the trim strip body to activate the heat activated adhesive layer disposed on the inside surface of the first side wall to bond the first side wall of the trim strip body to the first of the two sheets of drywall and (b) heat generated by the second heating member is adapted to be transferred through the second side wall of the trim strip body to activate the heat activated adhesive layer disposed on the inside surface of the second side wall to bond the second side wall of the trim strip body to the second of the two sheets of drywall.

### BRIEF DESCRIPTION OF THE DRAWINGS

The above needs are at least partially met through provision of the formable corner finishing and trim strip described in the following detailed description, particularly when studied in conjunction with the drawings, wherein:

FIG. 1A is top view of a portion of an embodiment of a formable trim strip;

FIG. 1B is a cross-sectional view of the embodiment of the formable trim strip taken along line I-I of FIG. 1;

FIG. 1C is a cross-sectional view of an alternative embodiment of the formable trim strip taken along line I-I of FIG. 1;

FIG. 1D is a cross-sectional view of another alternative embodiment of the formable trim strip taken along line I-I of FIG. 1;

FIG. 2 is a perspective view of an embodiment of a formable trim strip secured to a corner formed by two sheets of drywall;

FIGS. 3A-3C are cross-sectional views of alternative embodiments of a formable trim strip taken along line I-I of FIG. 1;

FIG. 4 is a cross-sectional view of an embodiment of a formable trim strip secured to a corner formed by two sheets of drywall;

FIG. 5 is a side view of one embodiment of a manufacturing system for manufacturing a trim strip according to the disclosure;

FIGS. 6A and 6B are schematic top and side views, respectively, of an embodiment of an assembly or kit for forming a formable trim strip for use on a corner of two sheets of drywall;

FIGS. 7A and 7B are cross sectional views of alternative embodiments of a die taken along line II-II of FIG. 6;

FIG. 8A is a top view of a portion of another alternative embodiment of a trim strip assembly;

FIG. 8B is a cross-sectional view of the embodiment of the trim strip assembly of FIG. 8A taken along line III-III;

FIG. 9 is cross-sectional view of an alternative embodiment of the trim strip assembly of FIG. 8A taken along line III-III;

FIG. 10A is a top view of a portion of an alternative embodiment of a trim strip assembly;

FIG. 10B is a cross-sectional view of the embodiment of the trim strip assembly of FIG. 10A taken along line IV-IV

FIG. 11A is a perspective view of an embodiment of an application tool adapted to secure a trim strip assembly along a corner formed by two sheets of drywall; and

FIG. 11B is a front view of the embodiment of the application tool illustrated in FIG. 11A.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

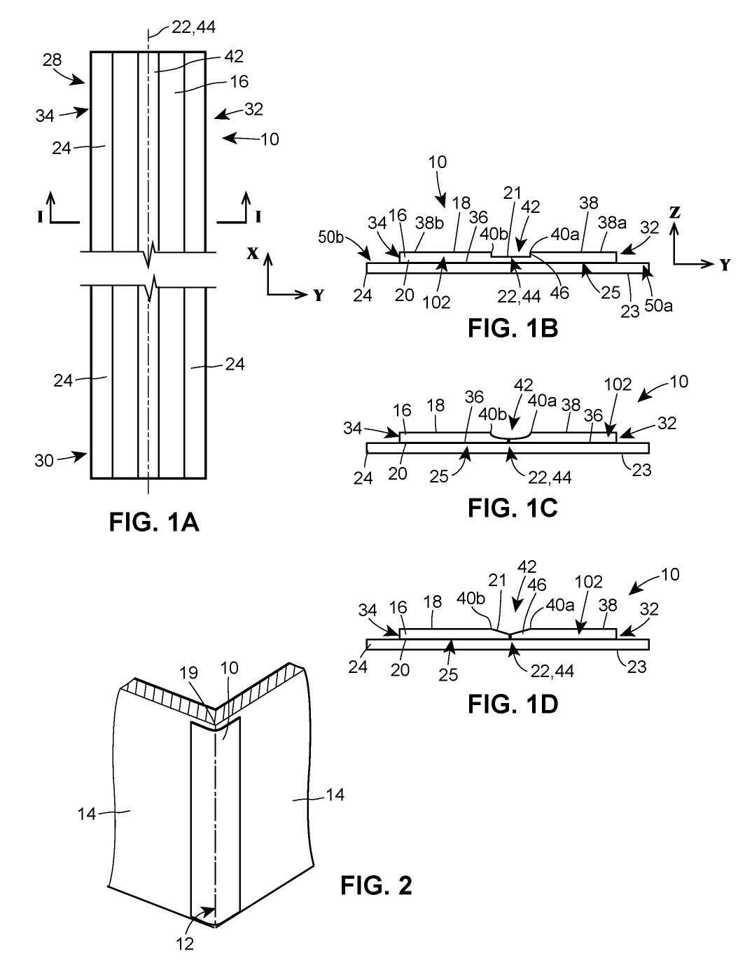

As illustrated in FIGS. 1A-2, a formable trim strip 10 is provided for use on a corner 12 formed by at least two sheets of drywall 14. With reference to FIGS. 1A and 1B, the formable trim strip 10 may have any number of layers and may include a trim strip body 16 having a top surface 18 and a bottom surface 20. The trim strip body 16 may extend along a body axis 22. The body axis 22 may extend longitudinally (that is, parallel to the X-axis of the reference coordinate system of FIGS. 1A and 1B). The trim strip body 16 may comprise or be made of a polymer material (e.g., a thermo-formable polymer) having a melting point range between about 250° F. and about 400° F. In some examples, the polymer used is DHM 5000 FA40, which is commercially available from DHM Adhesives Inc. of Calhoun, Ga., USA. Other examples of suitable polymers are possible. It is understood that the polymer may be a pure polymer or may include any number of fillers to provide desired characteristics such as increased flexibility, increased rigidity, decreased shrinkage, flame retardation, and the like. Some fillers may include calcium carbonate, silica, titanium oxide, colorants, carbon, glass, Kevlar, silanes, titanates, chlorine, bromine, and any other known fillers.

The formable trim 10 may also include a backing paper 24, a portion 25 of which, as will be described in further detail, may be affixed or secured to the bottom surface 20 of the trim strip body 16. When the portion 25 of the backing paper 24 is placed in contact with the bottom surface 20 of the trim strip body 16 when a temperature of the trim strip body 16 is within the melting point range, the polymer material itself acts as an adhesive. That is, when the polymer material cures and/or cools to a temperature outside of or below its melting point range, the portion 25 of the backing paper 24 is secured to, bonds to, and/or adheres to the bottom surface 20 of the trim strip body 16. Accordingly, an adhesive that is typically used to secure the trim strip body 16 to the backing paper 24 is eliminated, thereby eliminating the material cost of the adhesive and the manufacturing costs of adhesive application during production.

Turning to the formable trim strip 10 in more detail, the formable trim strip 10 (as well as the trim strip body 16) may be elongated and may extend along the body axis 22 from a first end 28 to a longitudinally-opposite second end 30, as illustrated in FIG. 1A. The distance between the first end 28 and the second end 30 may be any suitable distance, and may be longer than a typical length of trim strip such that a suitable portion or portions of the formable trim strip 10 may be cut to size for particular corner applications. In some versions, the trim strip 10 may be provided to customers/contractors coiled in a large roll thereby allowing custom lengths to be cut on the job site. A first side edge 32 of the trim strip 10 may be spaced a lateral distance (that is, a distance along the Y-axis of the reference coordinate system of FIGS. 1A and 1B) from a second side edge 34. The first side edge 32 and the second side edge 34 may extend along the body axis 22 such that the first side edge 32 and the second side edge 34 may laterally define the trim strip body 16, and the first side edge 32 may be separated a lateral distance of 1.00″ to 3.00″ (or about 1.00″ to about 3.00)″ from the second side edge 34. In some embodiments, the first side edge 32 and the second side edge 34 may be mutually parallel and parallel to the body axis 22.

As illustrated in FIG. 1B, the top surface 18 of the trim strip body 16 and the bottom surface 20 of the trim strip body 16 may extend between but not necessarily entirely between the first side edge 32 and the second side edge 34. This is because in some versions the backing paper 24 is wider than the trim body 16. The bottom surface 20 is planar or substantially planar to correspond with the planar configuration of the portion 25 of the backing paper 24. The bottom surface 20 may be defined in cross-section by a bottom edge 36 that may extend laterally or generally laterally when viewed in a cross-section normal to the body axis 22 (i.e., the cross-section view of FIG. 1B), and the bottom edge 36 may be a linear segment that extends between a bottom end of the first side edge 32 and a bottom end of the second side edge 34.

The top surface 18 is adapted to be placed in contact with an outer surface of a portion of the at least two sheets 14 of drywall when disposed along the corner 12 (as illustrated in FIGS. 2 and 4), and the top surface 18 may have any suitable shape to be used on or secured over the corner 12. The top surface 18 may be defined in cross-section by a top edge 38 that may extend laterally or generally laterally when viewed in a cross-section normal to the body axis 22 (i.e., the cross section view of FIG. 1B), and the top edge 38 may have any suitable shape or combination of shapes. For example, as illustrated in FIGS. 1B-1D, the top edge 38 may be linear and parallel to the bottom edge 36. The top edge 38 may be defined by two or more segments that extend between a top end of the first side edge 32 and a top end of the second side edge 34. For example, the top edge 38 may be at least partially defined by a first segment 38a that extends from the top end of the first side edge 32 to a first point 40a at, aligned with, or adjacent to the body axis 22. The top edge 38 may also be at least partially defined by a second segment 38b that extends from the top end of the second side edge 34 to a second point 40b at, aligned with, or adjacent to the body axis 22. The first point 40a may be coincident with the second point 40b or may be laterally offset from the second point 40b. The first and second segments 38a, 38b may be symmetrical about the body axis 22. The thickness of the first and second segments 38a, 38b, as well as the trim strip body 16 in general, may be between, in a non-limiting example, approximately 0.005″ and approximately 0.100″, such as a range of about 0.008″ to about 0.030″.

As illustrated in FIGS. 1A-1D, the formable trim strip 10 may also include at least one forming feature 42 that extends along at least a portion of the trim strip body 16. It is understood that in some examples, the formable trim strip 10 may not include a forming feature 42. The at least one forming feature 42 extends along a forming feature axis 44. The at least one forming feature 42 is configured to allow the trim strip body 16 to be deformed—or easily deformed—about the forming feature axis 44 and/or about the body axis 22. In some embodiments, when the formable trim strip 10 is deformed (e.g., folded) and positioned on a corner 12, an edge 19 defining the corner 12 may be disposed within a void 21 formed by the at least one forming feature 42, as illustrated in FIG. 4. In some embodiments, the at least one forming feature 42 may extend along the forming feature axis 44 from the first end 28 to the second end 30 of the trim strip body 16. In some embodiments, the forming feature axis 44 may be parallel to or collinearly aligned with the body axis 22.

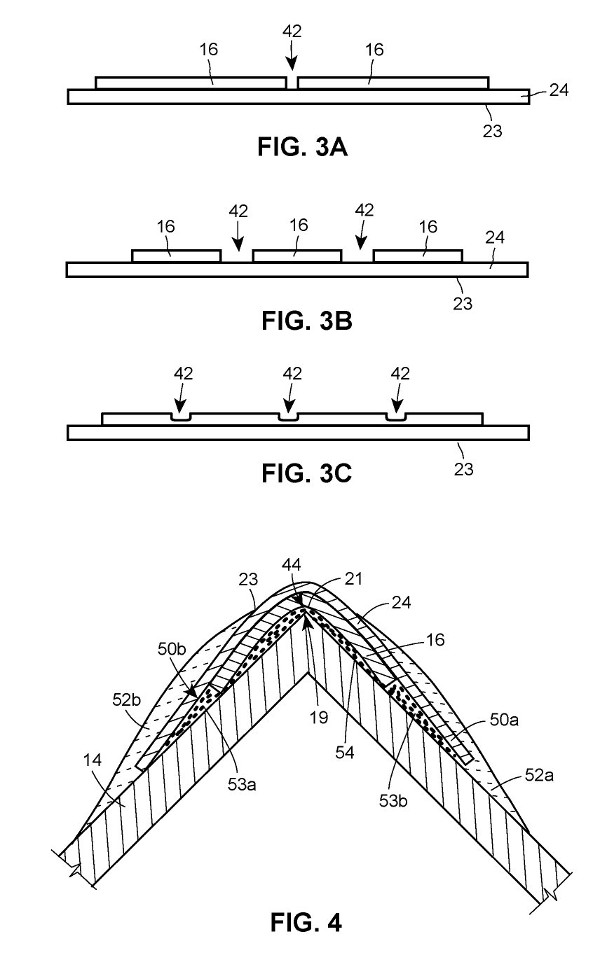

The at least one forming feature 42 may be defined by a forming feature edge 46 when viewed in cross-section, as illustrated in FIGS. 1B-1D. The forming feature edge 46 may extend from the first point 40a to the second point 40b, and the forming feature edge 46 may be at least partially comprised of two or more linear segments and/or one or more non-linear segments. The at least one forming feature 42 may have any suitable shape or combination of shapes to allow the trim strip body 16 to be deformed about a forming feature axis 44 after the formable trim strip 10 has cooled such that the temperate is lower than the lowest range of the melting point range. At such a temperature, the polymer is rigid or substantially rigid and is capable of protecting the corner 12 when installed. For example, as illustrated in FIG. 1B, the forming feature 42 may be a void defining a generally rectangular channel or slot adapted to facilitate bending of the trim strip 10 and optionally receive the edge 19 defining the corner 12. In other examples, and as illustrated in FIGS. 1C and 1D, the void of the forming feature 42 may have a U-shaped cross-section (FIG. 1C) or a 90-degree (e.g., V-shaped) cross-section (FIG. 1D), or any other desirable shape. A vertical distance between the bottom surface 20 and the lowermost portion of the forming feature edge 46 may be any suitable distance that facilitates bending but ensures that the trim strip body 16 will not be damaged when bent or formed about the forming feature axis 44, and the distance may be between approximately 0.01% to approximately 25% of the lateral width of the trim strip body 16. In some examples, and as illustrated in FIG. 3A, the void of the forming feature 42 may extend entirely through the body 16 such that it divides the trim strip body 16 into two separate segments.

The forming feature 42 may be formed using any number of tools which can form a void as the trim strip body 16 advances during manufacturer. For example, as will be described further below, during manufacture while the trim strip body 16 remains in a molten state at a temperature within its range of melting temperatures, a tool such as a pin, a wheel, a blade, of other such device may be introduced against the top surface 18 of the cooling trim strip body 16 in a manner that forms a depression or cut in the trim strip body 16 that remains after the trim strip body 16 cools and hardens. In other versions, it is foreseeable to use a tool to create the forming feature 42 during or after the trim strip body 16 cools. Such a tool could include a rotary or circular saw having any number of cross-sectional shapes, an etching device, a machining tool, etc.

In some embodiments, such as that illustrated in FIGS. 3B and 3C, a plurality of forming features 42 may extend across or along the top surface 18, and each of the plurality of forming features 42 may have any cross-sectional shape, dimension and geometry. For example, each of the plurality of forming features 42 may have an identical cross-sectional shape. In some embodiments, the plurality of forming features 42 may be U-shaped voids (e.g., grooves or recesses, as shown in FIG. 3C) that extend between elongated portions of the trim strip body 16. Each of the plurality of forming features 42 may extend along a corresponding forming feature axis 44 that may each be parallel to the body axis 22. Any or all of the plurality of forming features 42 may extend from the first end 38 to the second end 40 of the trim strip body 16. The trim strip body 16 may be bent or rotated about any, some, or all of the forming feature axes 44, and any of the plurality of forming features 42 may be adapted to receive the edge 19 defining the corner 12.

As previously mentioned, the formable trim strip 10 may include the backing paper 24, and the portion 25 of the backing paper 24 may be secured to the bottom surface 20 of the trim strip body 16. The backing paper 24 may be made of any suitable, durable material (such as, for example, a paper material, a woven fiber material, or other similar material or combination of materials), and the backing paper 24 may facilitate the attachment of the formable trim strip 10 to the drywall 14 by bonding with drywall joint compound during installation. In some versions, the backing paper 24 can be wallboard tape paper or other known industry materials. The backing paper 24 may extend along any suitable longitudinal length of the trim strip body 16, and the backing paper 24 may extend from the first end 28 to the second end 30 of the trim strip body 16. The backing paper 24 may have a lateral width that is greater than the lateral width of the trim strip body 16. In some embodiments, the backing paper 24 may have a lateral width that is equal to or substantially equal to the lateral width of the trim strip body 16. In other embodiments, such as the embodiment illustrated in FIG. 1B, a first portion 50a of the backing paper 24 may extend beyond the first side edge 32 of the trim strip body 16 (and beyond the portion 25 secured to the trim strip body 16), and a second portion 50b of the backing paper 24 may extend beyond the second side edge 34 of the trim strip body 16 (and beyond the portion 25 secured to the trim strip body 16). The first portion 50a and the second portion 50b may each have identical or nearly identical widths, and as a non-limiting example, the first portion 50a and the second portion 50b may each be approximately 0.250″ to approximately 0.750″, for example.

During manufacturing, the backing paper 24 is not attached to the trim strip body 16 by an adhesive. Instead, it is the adhesive properties of the material of the trim strip body 16 itself (as it cools from a temperature within a melting point range to a temperature outside or below the melting point range, or below the lowest temperature of the melting point range) that secures the portion 25 of the backing paper 24 to the bottom surface 20 of the trim strip body 16. That is, the trim strip body 16 is made of, fabricated from, and/or comprises a polymer material (such as a thermoformable polymer, e.g., ethylene vinyl acetate or poly alpha olefin) having a melting point range between about 250° F. and about 400° F. The melting point range may be defined as a range of temperatures of the material (or a portion of the material) in which the material has reached a melted (liquid or semi-liquid) state and is not in a fully solid state. The melting point range is also defined as a range of temperatures of the material (or a portion of the material) in which the material has reached a liquid or semi liquid state, forms a bond to surfaces (such as the backing paper 24), and will not sustain damage due to overheating.

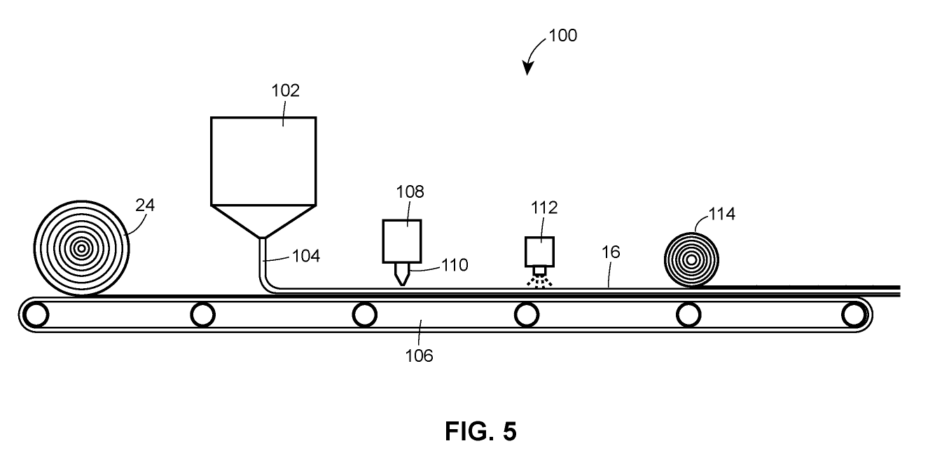

With reference now to FIG. 5, one system 100 and method for manufacturing the disclosed trim strip 10 will be described. While not necessarily depicted here, one system for applying the trim strip body 16 to the backing paper 24 could be an Acumeter coating machine commercially available from Acumeter Laboratories Incorporated. The system 100 in FIG. 5 generally includes a hopper 102 storing polymer material to be melted and formed into the trim strip body 16. The hopper 102 is disposed above a conveyor system 106 that moves paper backing 24 off of a roll and beneath an outlet port 104 of the hopper 102. Accordingly, when the trim strip body 16 is manufactured, the stock polymer material is heated in the hopper 102 to a temperature that is within the melting point range to move the polymer into a molten state. Simultaneously, the backing paper 24 is moved off of a roll and carried by the conveyor system 106 beneath the hopper 102. The molten polymer is then expelled from the outlet port 104 of the hopper 102 and deposited or coated directly onto the backing paper 24. In some versions, the outlet port 104 includes a specific geometry and/or configuration such that the molten polymer may be evenly deposited onto the backing paper 24 at the desired portion 25 create the desired shape. As the combined backing paper 24 and molten polymer travel away from the hopper 102 (to the right relative to the orientation of FIG. 5), the polymer begins to cool and harden into the trim strip body 16. As illustrated in FIG. 1B, the resulting trim strip body 16 may be generally rectangular in shape, and in other examples (as illustrated in FIG. 1D), the first and second side edges 32, 34 may be generally curved due to gravitational forces acting on the molten material as it cools. Other examples of cross-sectional shapes are possible.

As the trim strip body 16 cools to a temperature that is below the melting point range, the portion 25 of the backing paper 24 that supports the molten polymer bonds and/or becomes secured to the bottom surface 20 of the trim strip body 16. The cooling process that secures the portion 25 of the backing paper 24 to the bottom surface 20 of the trim strip body 16 may take any suitable amount of time, and the trim strip body 16 may cool to a cooling range (between approximately 40° F. and approximately 80° F.) before any further processing. No adhesive—and no manufacturing process applying adhesive—is required. Accordingly, the cost associated with both the material and the process is eliminated. When the trim strip body 16 cools to a temperature that is below the melting point range (and may be within the cooling range) and when the backing paper 24 is suitably secured to the bottom surface 20 of the trim strip body 16, the formable trim strip 10 may be then fully cured but yet flexible such that the formable trim strip 10 may be coiled or rolled (not shown) for transport to a retailer or a job site, for example. However, when the trim strip body 16 cools to a temperature that is below the melting point range, the formable trim strip 10 is sufficiently flexible that it may be deformed and unrolled, and ultimately bent about one or more of the forming feature axes 44 yet sufficiently rigid to protect the corner 12 when installed as described below.

It is understood that the forming feature or features 42 may be formed at different points in the manufacturing process. For example, the forming feature 42 may be formed while the body material is within the melting point range or after the material has cooled and formed the trim strip body 16. In those embodiments where the forming feature 42 comprises one or more recesses, channels or grooves in the trim strip body 16 (see, e.g., FIGS. 1B, 1C, 1D, and 3C) such features 42 may be formed by a tooling device 108 such as that depicted in FIG. 5. The device 108 may include a tool 210 such as a pin, a knife, a wheel, etc., for directly engaging and forming the forming feature 42 into the molten polymer material before it hardens into the trim strip body 16. In some versions, the tool 210 could be selected from a plurality of available tools for creating a forming feature 42 of a desired shape. In some versions, the tool 110 may resemble a fork or other arrangement with multiple points of contact with the molten material such that the arrangement of multiple forming features 42 depicted in FIG. 3C could easily be achieved. For other versions of the trim strip 10 where the trim strip body 16 includes two or more segments separated by a gap (see, e.g., FIGS. 3A and 3B), this may be achieved by the hopper 102 in the system of FIG. 5 having two or more separate side-by-side outlet ports 104 such that two or more parallel portions of the trip strip body 16 can be coated onto the backing paper 24 simultaneously. In still other versions that are not depicted in in the drawings of the present application, it is foreseeable to have a trim strip 10 that includes a trim strip body 16 with both gaps (as shown in FIGS. 3A and 3B) and recesses, channels, or grooves (as shown in FIGS. 1B, 1C, 1D and 3C). Thus, it would be appreciated that the system 100 in FIG. 5 could include a combination of multiple outlet ports 104 (whether form a common or separate hoppers) and one or more tools 110 each having one or more points of contact with the molten polymer.

Further, any number of additional manufacturing processes may be implemented before or after the formation of the trim strip body 16. For example, the formable trim strip 10 may include any number of additional layers such as an adhesive layer applied to the top surface 18 of the trim strip body 16 to assist in securing the formable trim strip 10 to the wall. This adhesive layer may be applied after or at the same time the trim strip body 16 is flowed, deposited, or coated onto the backing paper 24. With such an arrangement, the applied adhesive opposite the backing paper 24 would be utilized to actually secure the trim strip 10 to the drywall at the construction site. It is understood that a number of suitable approaches to applying the adhesive may be used, such as, for example, spraying via a nozzle, rolling, film, painting, and the like. In the system of FIG. 5, an adhesive applicator 112 is depicted downstream of the tooling device 208 and this applicator 112 could be a spray applicator, a roller applicator, a film applicator, etc. In some of these examples, an additional release layer may be applied over the adhesive surface which can be removed prior to affixing the formable trim strip 10 to the corner 12. In FIG. 5, one version of the manufacturing system 100 can include a roll of release layer 114 disposed downstream of the adhesive applicator which can be applied over the adhesive after the adhesive is applied to the trim strip body 16. Other examples are possible.

Once at the job site, when it is desired to secure the formable trim strip 10 on or over a corner 12 formed by at least two sheets 14 of drywall, a suitable length of the formable trim strip 10 may be uncoiled and cut to desired dimensions based on the length of the corner 12. This (or any) length of formable trim strip 10 may extend from the first end 28 to the second end 30, and if more than one portion of the formable trim strip 10 is cut from a single coil, each portion of the formable trim strip 10 may extend from the first end 28 to the second end 30. The formable trim strip 10 can then be bent by any suitable angle along the forming feature axis 44 (which may be parallel to the body axis 22) to fit around a desired corner 12. For example, as illustrated in FIG. 4, the formable trim strip 10 can then be bent along the forming feature axis 44 over a corner having any angle less or greater than 180° and secured to the drywall 14 using any known manner.

In some examples, materials such as drywall joint compound and/or adhesives may be used to secure the trim strip 10 to drywall. For example, as depicted in FIG. 4, one application technique includes applying portions 53a, 53b of joint compound to the top surface 18 of the trim strip body 16 and the immediately adjacent portions 50a, 50b of the backing paper 24. The trim strip 10 is then applied to the wall, and additional portions 52a, 52b of joint compound is applied to fill side recess 52a, 52b formed along an outer surface 23 of the backing paper 24 adjacent to the trim strip body 16. This material can be used to create a smooth corner surface free of blemishes and to increase the adhesion of the formable trim strip 10 to the corner.

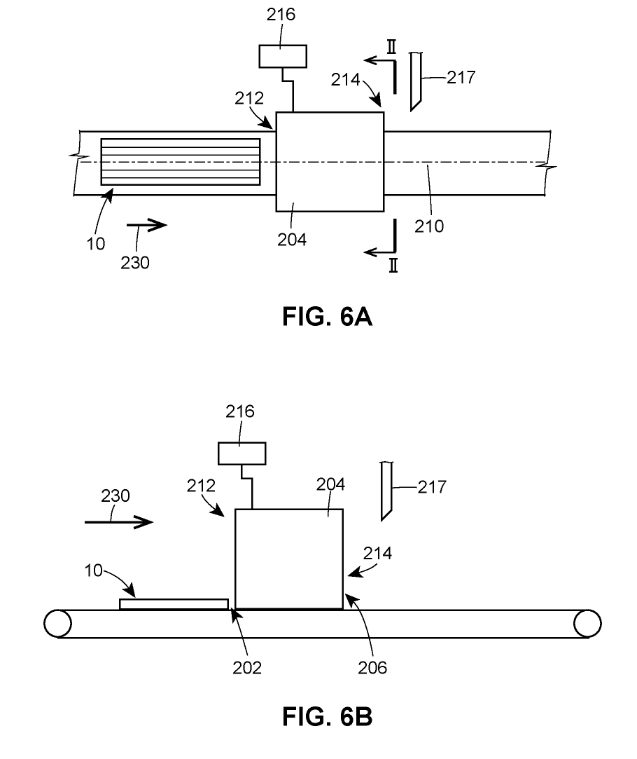

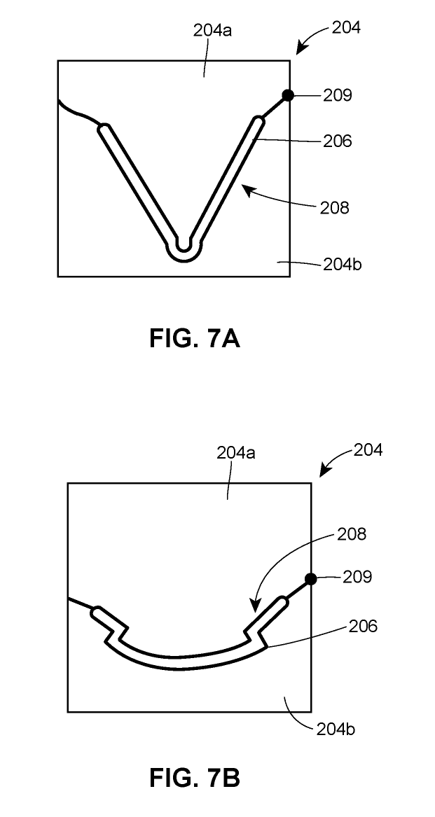

Referring now to FIGS. 6-7B, an assembly 200 (or system or kit) may be used to form the previously discussed formable trim strip 10 for use on a corner 12 of two sheets of drywall. The assembly can include a die 204 having an aperture 206 (FIGS. 7A and 7B) having a second cross-sectional shape 208 that is different than a first cross-sectional shape 202 (as illustrated in various example forms in FIGS. 1B-1D) of the formable trim strip 10. For example, as illustrated in FIG. 7A, which illustrates an example die 204 cross-section, the second cross-sectional shape 208 may have a 90-degree shape (or a general V-shape), and in other examples, as illustrated in FIG. 7B, an example die 204 has a bull-nosed second cross-sectional shape 208. In some versions, the die 204 can include a clamshell or sandwich type construction such that when opened (not shown), the formable trim strip 10 is positioned between opposing first and second portions 204a, 204b of the die 204. Then, once the die 204 is closed (depicted in FIGS. 7A, 7B), the trim strip 10 can be pushed or pulled out of the die 204 through the aperture 206. Such clamshell or sandwich type dies 204 may include a hinge 209 for moving the first portion 204a of the die 204 relative to the second portion 204b of the die 204 between open and closed (depicted in FIGS. 7A, 7B) positions. In other versions, the die 204 may be of single piece construction and the first aperture 206 may be adapted to slidably receive (or movably or displaceably receive) the formable trim strip 10 such that as the formable trim strip body is displaced (e.g., pushed or pulled) through the aperture 206. The formable trim strip body 16 of the formable trim strip 10 is changed, modified, altered, or adjusted from having the first cross-sectional shape 202 to a cross-sectional shape that corresponds to the second cross-sectional shape 208.

Referring to FIG. 6A, the first aperture 206 may extend along a longitudinal axis 210 of the die 204, and the first aperture 206 may be uniform or constant over the length of the longitudinal axis 210. This is particularly true when the die 204 includes a clamshell or sandwich type construction as discussed above.

In other examples, including those for example where the die 204 is of single piece construction, a geometry or profile of the first aperture 206 may change along the longitudinal axis 210 from a first end 212 of the die 204 to a second end 214 of the die 204. That is, at the first end 212, the first aperture 206 may have a cross-sectional shape that closely corresponds to the first cross-sectional shape 202 and at the second end 214, the first aperture 206 may have a cross-sectional shape that corresponds to the second cross-sectional shape 208. Accordingly, the formable trim strip 10 may be easily inserted into the die 204 without needing manipulation.

The transition between the first cross-sectional shape 202 at the first end 212 and the second cross-sectional shape 208 at the second end 214 may be gradual, and the die 204 may have any suitable longitudinal length between the first end 212 and the second end 214 to allow the cross-sectional shape of the formable trim strip 10 to be changed from the first cross-sectional shape 202 to the second cross-sectional shape 208.

As shown in FIG. 6A, a heating element 216 may be thermally coupled to the die 204 to heat the trim strip body 16 of the formable trim strip 10 to a temperature within a softening point range of the polymer material used to construct the trim strip body 16. In some embodiments, the heating element 216 may heat the die 204 to a temperature within the softening point range of the polymer material. The softening point range may be defined as a range of temperatures of the material (or a portion of the material) forming the trim strip body 16 in which the material can be formed or shaped using moderate pressure, but in which the material does not flow as a liquid or semi-liquid. The highest temperature within the softening point range may be below the lowest temperature of the melting point range so that during the forming process, the material does not melt. The polymer material of the trim strip body 16 may have softening point range between approximately 110° F. and approximately 210° F., and more particularly, between approximately 125° F. and approximately 175° F.

When a suitable portion of the formable trim strip 10 emerges or exits from the second end 214 of the of the die 204, a cutting element 217 may be used to cut the formable trim strip 10 to a desired longitudinal length, thereby creating a new first end 28 and second end 30. The cutting element 217 may be any suitable blade or blade assembly capable of cutting the formable trim strip 10 in a lateral direction, such as a blade that moves normal to the longitudinal axis 210.

In some examples, the assembly 200 may include a kit that includes any number of alternative dies having different apertures. These additional dies can be used to alter the cross-sectional shape of the trim strip body 16 based on customer demands, for example, and can operate in a similar manner to the die 204.

In use, the trim strip body 16 of formable trim strip 10 is advanced through the first aperture 206 of the die 204 (along arrow 230 of FIG. 6) as described. Thus, as the formable trim strip 10 exits the second end 214 of the first aperture 206, the formable trim strip 10 (and the trim strip body 16 of the trim strip 10) will be formed or molded to have a cross-sectional shape that corresponds to the second cross-sectional shape 208. The formable trim strip 10 may then be cut to size using the cutting element 217. The cutting may occur before or after the trim strip body 16 has a temperature within the cooling range. If a different cross-sectional shape of trim strip is required, a suitable die is used (i.e., an alternative second die), and the trim strip body 16 of the formable trim strip 10 is advanced through a second aperture of this second die.

Accordingly, when the material of the formable trim strip 10 is cooled to a temperature below the softening point range (e.g., to a temperature within the cooling range) after forming by the die 204, the formable trim strip 10 maintains its second cross-sectional shape 208 yet remain rigid. As such, this system advantageously enables on site forming of custom shaped trim strips. Because the final product, after forming, is rigid and holds the angle or curve that has been formed, the finishing will be of higher quality and greater versatility than when using a conventional flexible plastic strip.

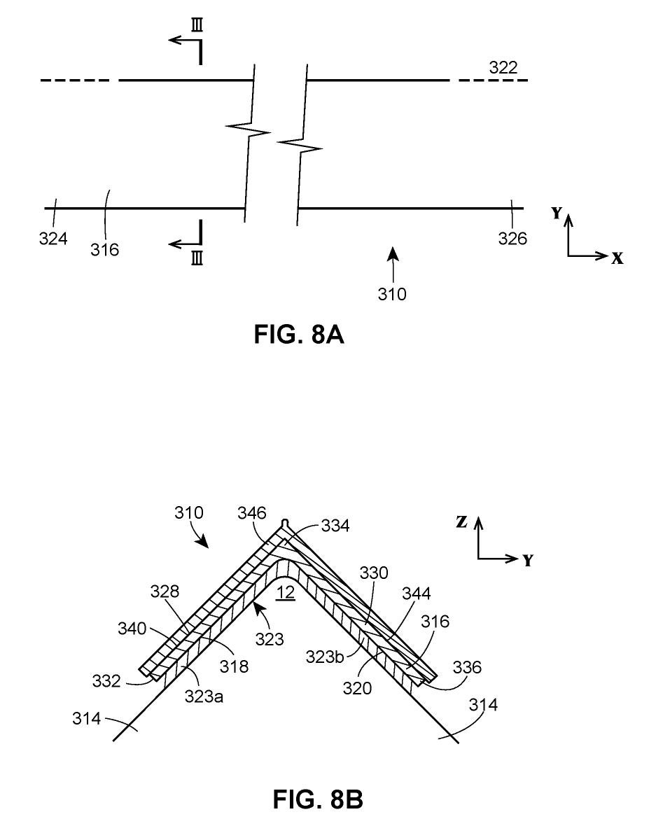

As illustrated in FIGS. 8A and 8B, a formable trim strip assembly 310 is provided for use on a corner formed by at least two sheets of drywall 314. The trim strip assembly 310 may include a trim strip body 316 extending along a body axis 322 that may extend longitudinally (that is, parallel to the X-axis of the reference coordinate system of FIG. 8A), and the trim strip body 316 may have at least one inside surface 318, which may correspond to the upper surface 18 previously discussed. The inside surface 318 may be an inside surface of a first side wall 328 of the trim strip body 314. In some embodiments, the trim strip body 316 may also include an inside surface 320 of a second side wall 330 of the trim strip body 316. The first side wall 328 and the second side wall 330 may have a 90-degree (e.g., V-shaped) cross-section when viewed along the body axis 322. The trim strip assembly 310 also includes an adhesive layer 323 formed over at least a portion of the at least one inside surface 318 of the trim strip body 316 (e.g., the inside surface 318 of the first side wall 328). In some examples, the adhesive layer 323 has a softening point range such that when the adhesive layer 323 is heated to a temperature within the softening point range, the adhesive layer 323 bonds to at least one of the at least two sheets of drywall 314 to secure the trim strip body 316 to at least one of the at least two sheets of drywall 314.

So configured, by heating the adhesive layer 323 to a temperature within the softening point range and applying the trim strip assembly 310 over the corner 12, the adhesive layer 323 bonds to at least one of the least two sheets of drywall 314. Importantly, because the bond is formed nearly instantaneously, thereby eliminating the need for both mechanical fasteners and the use of the slow-drying joint compound. In addition, by eliminating the need for mechanical fasteners and joint compound, the trim strip assembly 310 presents an esthetically-pleasing low-profile when secured over the corner 12.

The trim strip body 316 may be elongated and may extend along the body axis 322 from a first end 324 to a longitudinally-opposite second end 326, as illustrated in FIG. 8A. The distance between the first end 324 and the second end 326 may be any suitable distance for a particular corner application. The trim strip body 316 may include the first side wall 328 and a second side wall 330, and the first side wall 328 and the second side wall 330 may extend from the first end 324 and the second end 326. The first side wall 328 and the second side wall 330 may each be planar, and a top portion of the first side wall 328 may be integrally formed with or coupled to a top portion of the second side wall 330 such that the first side wall 328 and the second side wall 330 have (or cooperate to form) a cross-sectional shape of a “V” when viewed along the body axis 322. In some embodiments, the first side wall 328 and the second side wall 330 may each be curved or have curved portions, and a top portion of the first side wall 328 may be integrally formed with or coupled to a top portion of the second side wall 330 such that the first side wall 328 and the second side wall 330 have (or cooperate to form) a cross-sectional shape of a “U” when viewed along the body axis 322.

As illustrated in FIG. 8B, the first side wall 328, when viewed in cross-section, may extend from a bottom edge 332 to an upper edge 334 at the top portion of the first side wall 328. In addition, the second side wall 330 may extend from a bottom edge 336 to the upper edge 334 at the top portion of the second side wall 30. When viewed in cross-section, the first side wall 328 may form any suitable angle with the second side wall 330. This angle may typically be between approximately 60° and approximately 120°, for example, approximately 90°. The first side wall 328 may include the inside surface 318 and an outside surface 340 opposite to the inside surface 318. Similarly, the second side wall 330 may include the inside surface 320 and an outside surface 344 opposite to the inside surface 320. The first side wall 328 and the second side wall 330 may each have any suitable thickness or combination of thicknesses. In some embodiment, the bottom edge 332 of the first side wall 328 and the bottom edge 336 of the second side wall 330 may be mutually parallel and parallel to the body axis 322. The upper edge 334 may be parallel and co-linearly aligned with the body axis 322.

As previously described, the trim strip body 316 may be made of, fabricated from, and/or comprise a polymer material (such as, for example, a polystyrene, polyolefin, polyester, polyvinyl chloride, or acrylonitrile butadiene styrene) having a melting point range between about 250° F. and about 450° F. In other embodiments, the trim strip body 316 may be made of, fabricated from, and/or comprise a heavy paper material (such as cardboard) alone or in combination with a polymer such as an infused polymer or absorbed polymer. Other examples are possible.

As illustrated in FIG. 8B, a backing paper 346 may be secured to the outside surface 340 of the first side wall 328 of the trim strip body 316 and the outside surface 344 of the second side wall 330 of the trim strip body 316. The backing paper 46 may be made of any suitable, durable material (which may be a paper material, a woven fiber material, or other similar material or combination of materials), and the backing paper 46 may facilitate the attachment of the trim strip assembly 10 to the drywall 314 by bonding with drywall joint compound during installation.

As illustrated in FIG. 8B, the trim strip assembly 10 also includes the adhesive layer 323 formed over or disposed on at least a portion of the inside surface 318 of the trim strip body 316. As previously explained, the inside surface 318 may be the inside surface 318 of the first side wall 328 of the trim strip body 316, and a first portion 323a of the adhesive layer 323 may be formed over or disposed on the entire inside surface 318 of the first side wall 328 or a portion thereof. In addition, a second portion 323b of the adhesive layer 323 may be formed over or disposed on the entire inside surface 320 of the second side wall 330 or a portion thereof. In some embodiments, the first portion 323a of the adhesive layer 323 and the second portion 323b of the adhesive layer 323 may be integrally formed at or adjacent to the upper edge 334 at the top portion of the first side wall 28 and the second side wall 330. In other embodiments, the first portion 323a of the adhesive layer 323 may be separated from the upper edge 34 at the top portion of the first side wall 328 by a gap that extends parallel to the upper edge 334, and the second portion 323b of the adhesive layer 323 may be separated from the upper edge 334 at the top portion of the second side wall 330 by a gap that extends parallel to the upper edge 334.

The adhesive layer 323 may be made from or comprise any material having a softening point range such that when the adhesive layer 323 is heated to a temperature within the softening point range, the adhesive layer 323 bonds to at least one of the at least two sheets of drywall 314 to secure the trim strip body 316 to the at least one of the at least two sheets of drywall 314. The softening point range may be a range of temperatures in which the material (or a portion of the material) forming the adhesive layer 323 has adhesive properties or qualities, and when temperatures of the material (or a portion of the material) forming the adhesive layer 323 are below the softening point range, the material (or a portion of the material) forming the adhesive layer 323 does not have adhesive properties or qualities. The highest temperature within the softening point range may be below the lowest temperature of the melting point range so that during the activation (or heating) process of the adhesive layer 323, the material comprising or forming the trim strip body 316 does not melt. In some embodiments, the softening point range is between approximately 125° F. and approximately 225° F. The adhesive layer 323 may be any suitable material having a suitable softening point range, such as a heat-activated hot melt adhesive. For example, the material may be ethylene vinyl acetate or poly alpha olefin.

The adhesive layer 323 may be formed or distributed over the inside surface 318 of the first side wall 328 and/or the inside surface 320 of a second side wall 330 in any suitable manner to allow the material forming the adhesive layer 323 to form a bond or be secured to one or both of the at least two sheets of drywall 314. For example, the first portion 323a of the adhesive layer 323 and/or the second portion 323b of the adhesive layer 323 may be formed or distributed as an even, uniform layer over the inside surface 318 of the first side wall 328 and/or the inside surface 320 of the second side wall 330. In other embodiments, the first portion 323a of the adhesive layer 323 and/or the second portion 323b of the adhesive layer 323 may be formed as strips, patterns, shapes, or any combination therefor that include gaps between portions of the first portion 323a and/or the second portion 323b.

To secure the trim strip assembly 310 to the corner 12 formed by the at least two sheets of drywall 314, a user may first position the trim strip assembly 310 in a desired corner location. In such a position, the adhesive layer 323 (e.g., the first portion 323a of the adhesive layer 323 and the second portion 323b of the adhesive layer 323) may be positioned to be in contact with (or adjacent to) one or more corresponding portions of the first sheet of drywall 314 and/or one or more corresponding portions of the second sheet of drywall 314. In some embodiments, the first portion 323a of the adhesive layer 323 may be positioned to be in contact with (or adjacent to) one or more corresponding portions of the first sheet of drywall 314 and the second portion 323b of the adhesive layer 323) may be positioned to be in contact with (or adjacent to) one or more corresponding portions of the second sheet of drywall 314. A heating element or tool (an embodiment of which will be described in more detail below) may be placed on (or adjacent to) the trim strip body 316 (and, in some embodiments, over the backing paper 346 or in contact briefly with the adhesive layer 323) to heat the adhesive layer 323 to a temperature within the softening point range (and below the lowest temperature at which the material of trim strip body 316 begins to melt). The heating element or tool may be a flat iron or other hand held iron (not shown) that may be placed in contact with a flat portion of the trim strip body 316 or a shaped heating tool (not shown) that may correspond to the shape of the trim strip body 316 and may be placed in contact with a longitudinal lengthwise portion of the trim strip body 316.

After a suitable amount of heating time, the adhesive or bonding qualities of the adhesive layer 323 are activated and the adhesive layer 323 bonds to one or more corresponding portions of the first sheet of drywall 314 and/or one or more corresponding portions of the second sheet of drywall 314 to secure the trim strip assembly 310 to at least one of the first or second sheets of drywall 314. In some embodiments, the first portion 323a of the adhesive layer 323 may be heated to a temperature within the softening point range and may secure the first side wall 328 of the trim strip assembly 310 to the first sheet of drywall 314 and the second portion 323b of the adhesive layer 323 may be heated to a temperature within the softening point range and may secure the second side wall 330 of the trim strip assembly 310 to the second sheet of drywall 314.

In some embodiments, the adhesive layer 323 may be heated to a temperature within the softening point range (and below the lowest temperature at which the material of trim strip body 316 begins to melt) prior to positioning the trim strip assembly 310 in a desired corner location. In such an embodiment, trim strip assembly 310 may be placed in or pushed through a stationary heater to heat the adhesive layer. Subsequently, the pre-heated first portion 323a of the adhesive layer 323 may secure the first side wall 328 of the trim strip assembly 310 to the first sheet of drywall 314 and the pre-heated second portion 323b of the adhesive layer 323 may secure the second side wall 330 of the trim strip assembly 310 to the second sheet of drywall 314. A corner rolling tool, flat iron, or any other device (not shown) may also be used to apply pressure to the first side wall 328 and/or the second side wall 330 of the trim strip body 316.

When the adhesive layer 323 cools to a temperate lower than the lowest temperature of the softening point range, the adhesive layer 323 provides a secure bond to and/or a permanent bond with the one or more corresponding portions of the first sheet and/or one or more corresponding portions of the second sheet of drywall 314.

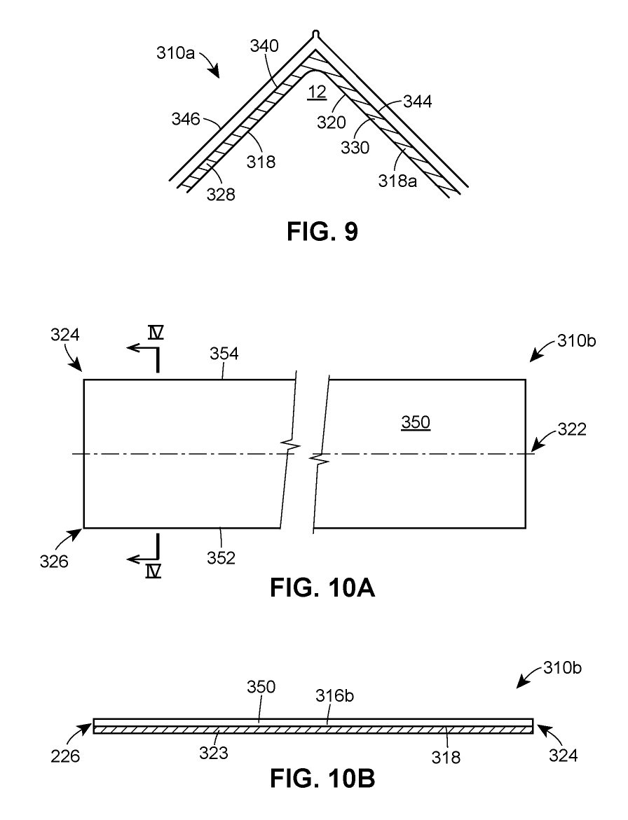

Referring to FIG. 9, an embodiment of the trim strip assembly 310a may include a trim strip body 316a that may be nearly identical to the trim strip body 316 previously described, and accordingly, like reference numbers will not be changed. However, the trim strip body 316a of the trim strip assembly 310a may be made of, fabricated from, and/or comprise an adhesive material, and therefore the trim strip assembly 310a does not have an adhesive layer 323 formed or distributed over the inside surface 318 of the first side wall 328 and/or the inside surface 320 of a second side wall 330. More specifically, the entire trim strip body 316a may be made from or comprise any material having a softening point range such that when the trim strip body 316a is heated to a temperature within the softening point range, portion of the trim strip body 316a in contact with any of the at least two sheets of drywall 314 are bonded to the at least two sheets of drywall 314 in the same manner that the adhesive layer 323 bonds with the at least two sheets of drywall 314. That is, when the trim strip assembly 310a is applied to a corner 12 as previously described, the inside surface 318 of the first side wall 328 bonds to the first sheet of drywall 314 and/or the inside surface 320 of the second side wall 330 bonds to the second sheet of drywall 314. In some embodiments of the trim strip assembly 310a, the material comprising the trim strip body 316a may have a softening point range is between approximately 125° F. and approximately 175° F. The adhesive layer 323 may be any suitable material having a suitable softening point range, such as a heat-activated hot melt adhesive.

A further embodiment of the trim strip assembly 310b is illustrated in FIGS. 10A and 10B. In the trim strip assembly 310b, the trim strip body 316b is a length of flexible tape or paper that may have a cross-sectional shape of a thin rectangle when laid flat prior to securing over a corner 12. Because the trim strip body 316b is flexible, the trim strip body 316b may be coiled or rolled prior to application for convenient storage. When in a flattened or planar configuration (as illustrated in FIG. 10A), the trim strip body 316b (i.e., the flexible tape or paper) may extend from the first end 324 to the second end 326 along the body axis 322. The trim strip body 316b may have an inside surface 318, which may be a bottom surface of the trim strip body 316b, and a top surface 350. The trim strip body 316b may be defined by a first lateral edge 352 and a second lateral edge 354 that each may extend along (or parallel to) the body axis 322. The first lateral edge 352 and the second lateral edge 354 may each be equidistant or substantially equidistant from the body axis 322.

The trim strip assembly 310b may also include the adhesive layer 323 formed over at least a portion of the inside surface 318 of the trim strip body 316b (e.g., the inside surface 318 of the first side wall 328). As illustrated in FIG. 10B, the adhesive layer 323 may be formed over the entire inside surface 318 of the trim strip body 316b (i.e., from the first end 324 to the second end 326 between the first lateral edge 352 and the second lateral edge 354. The adhesive layer 323 may be identical to those previously described, and the adhesive layer 323 may be made from or comprise any material (such as a heat-activated hot melt adhesive) having a softening point range such that when the adhesive layer 323 is heated to a temperature within the softening point range, the adhesive layer 323 bonds to at least one of the at least two sheets of drywall 314 to secure the trim strip body 316b thereto.

To secure the trim strip assembly 310b to the corner 12 formed by the at least two sheets of drywall 314, a user may first heat the trim strip assembly 310b such that the temperature of the adhesive layer 323 is within the softening point range, as previously described. The trim strip assembly 310b may then be positioned in a desired corner location such that a first portion (e.g., a portion between the body axis 322 and the first lateral edge 352) is positioned over a portion of the first sheet of drywall 314 and a second portion (e.g., a portion between the body axis 322 and the second lateral edge 354) is positioned over a portion of the second sheet of drywall 314. So assembled, the trim strip assembly 310b may have a 90-degree or V-shaped cross-section when viewed along the body axis 322, similar to the shape of the trim strip body 316 illustrated in FIG. 8B. In other embodiments, the trim strip assembly 310b may first be positioned on the corner 12 as described (and temporarily secured to the sheets of drywall 314) and then a heating element or tool may activate the adhesive layer 323, as previously described. Because the trim strip body 316b and the adhesive layer 323 are both flexible, the trim strip assembly 310b can be quickly and easily secured to a corner 12 having any cross-sectional shape.

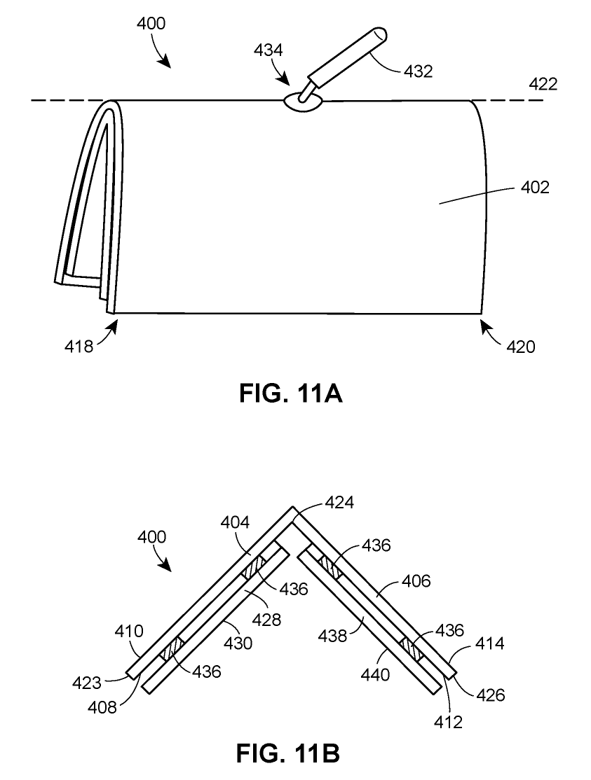

As previously explained, a heating element or tool may be placed on (or adjacent to) the trim strip body 316 (and, in some embodiments, over the backing paper 346) to heat the adhesive layer 323 to a temperature within the softening point range. Such a heating tool may be an embodiment of the application tool 400 of FIGS. 11A and 11B. The application tool 400 may include a base member 402 having a first base wall 404 and a second base wall 406. The first base wall 404 may have an inside surface 408 and an outside surface 410, and the second base wall 406 having an inside surface 412 and an outside surface 414. The base member 402 may be elongated and may extend parallel to a base axis 422 from a first end 418 to a second end 420. The distance between the first end 418 and the second end 420 may be any suitable distance for a particular corner application, and the first base wall 404 and the second base wall 406 may extend from the first end 418 and the second end 420.

The first base wall 404 and the second base wall 406 may each be planar, and a top portion of the first base wall 404 may be integrally formed with or coupled to a top portion of the second base wall 406 such that the first base wall 404 and the second base wall 406 have a cross-sectional shape of a “V” (when viewed along the base axis 422). The first base wall 404 and the second base wall 406 may each be curved or have curved portions, and a top portion of the first base wall 404 may be integrally formed with or coupled to a top portion of the second base wall 406 such that the first base wall 404 and the second base wall 406 have a cross-sectional shape of a “U” (when viewed along the base axis 422).

When viewed in cross-section, the first base wall 404 may extend from a bottom edge 423 to an upper edge 424 at the top portion of the first base wall 404. In addition, the second base wall 406 may extend from a bottom edge 426 to the upper edge 424 at the top portion of the second base wall 406. When viewed in cross-section, the first base wall 404 may form any suitable angle with the second base wall 406, and the angle may typically be between approximately 60° and approximately 120°, and the angle may preferably be approximately 90°. The first base wall 404 and the second base wall 406 may each have any suitable thickness or combination of thicknesses. In some embodiments, the bottom edge 423 of the first base wall 404 and the bottom edge 426 of the second base wall 406 may be mutually parallel and parallel to the base axis 422. The upper edge 424 may be parallel and co-linearly aligned with the base axis 422.

The application tool 400 may also include a first heating member 428 directly or indirectly coupled to the inside surface 4108 of the first base wall 404 of the base member 102. The first heating member 428 may be planar or substantially planar and may extend from the first end 418 to the second end 420 of the base member 402. The first heating member 428 may have a width that is greater than a corresponding width of the first side wall 328 of the trim strip body 216. The first heating member 428 may have an application surface 340 that is adapted to contact the outside surface 340 of the first side wall 328 of the trim strip body 216 when the application tool 400 is positioned along the trim strip assembly 210 that is positioned over the corner 12. Heat generated by the first heating member 428 is transferred (or adapted to be transferred) through the first side wall 328 of the trim strip body 216 to activate the heat activated adhesive layer 323 (e.g., the first portion 323a) disposed on the inside surface 218 of the first side wall 328 to bond the first side wall 328 of the trim strip body 216 to the first sheet of the two sheets of drywall 214. The first heating member 428 may be connected to a power source (e.g., a battery, not shown) that provides power to heat all or a portion of the first heating member 428 to a temperature that is sufficient to heat the adhesive layer 323 (i.e., the first portion 323a of the adhesive layer 323) to a temperature within the softening point range. The first heating member 428 may generate heat in any suitable manner, such as by heating coils or wires (not shown).

The first heating member 428 may also be adapted to provide pressure on the trim strip body 216 and the adhesive layer 323 formed on the trim strip body 216 to facilitate bonding between the adhesive layer 323 and a corresponding one of the two sheets of drywall 214. Specifically, a user may provide pressure on the base member 402 by pressing the base member 402 towards the corner 12 when the base member 402 is properly positioned along the corner edge. In other alternatives, pressure may be applied to the base member 402 such by using a handle 432 that may be movably coupled to the base member 402. In some embodiments, the handle 432 may be movably coupled to the base member 402 by a ball and socket joint 434. In some embodiments, the first heating member 428 may be coupled to the inside surface 408 of the first base wall 404 of the base member 402 using one or more resilient members 436, which may be, for example, one or more springs or one or more resilient pads. So configured, pressure applied by a user to the base member 402 may be transferred by the application surface 4340 to the first side wall 328 and to the first portion 323a of the adhesive layer 323 to fix or secure the first side wall 328 and the first portion 323a of the adhesive layer 323 to the first sheet of drywall 214 forming the corner 12.

The application tool 400 may also include a second heating member 438 directly or indirectly coupled to the inside surface 412 of the second base wall 406 of the base member 402. The second heating member 438 may be identical to (or substantially identical to) the first heating member 428. Specifically, the second heating member 438 may be planar or substantially planar and may extend from the first end 418 to the second end 420 of the base member 402. The second heating member 438 may have a width that is greater than a corresponding width of the second side wall 430 of the trim strip body 316. The second heating member 438 may have an application surface 340 that is adapted to contact the outside surface 344 of the second side wall 330 of the trim strip body 216 when the application tool 400 is positioned along the trim strip assembly 210 that is positioned over the corner 12. Heat generated by the second heating member 438 is transferred (or adapted to be transferred) through the second side wall 330 of the trim strip body 216 to activate the heat activated adhesive layer 323 (e.g., the second portion 323b) disposed on the inside surface 320 of the second side wall 330 to bond the second side wall 330 of the trim strip body 216 to the second sheet of the two sheets of drywall 214. The second heating member 438 may be connected to a power source (e.g., the same power source that is connected to the first heating member 428) that provides power to heat all or a portion of the second heating member 438 to a temperature that is sufficient to heat the adhesive layer 323 (i.e., the second portion 323b of the adhesive layer 323) to a temperature within the softening point range. The second heating member 438 may generate heat in any suitable manner, such as by heating coils or wires (not shown).

In a manner identical to the first heating member 430, the second heating member 438 may also be adapted to provide pressure on the trim strip body 216 and the adhesive layer 323 formed on the trim strip body 216 to facilitate bonding between the adhesive layer 323 and a corresponding one of the two sheets of drywall 214. In some embodiments, the second heating member 438 may be coupled to the inside surface 412 of the second base wall 406 of the base member 402 using one or more resilient members 436, which may be, for example, one or more springs or one or more resilient pads. So configured, pressure applied by a user to the base member 402 may be transferred by the application surface 340 to the second side wall 330 and to the second portion 323b of the adhesive layer 323 to fix or secure the second side wall 330 and the second portion 323b of the adhesive layer 323 to the second sheet of drywall 214 forming the corner 12. The distance between the first end 418 and the second end 420 of the base member may be significantly less than the distance between the first end 324 and the second end 326 of the trim strip body 216 such that the application tool 400 must be placed over portions of the trim strip assembly 210 to fully secure the trim strip assembly 210 along the entire corner 12.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A trim strip assembly for use on a corner of at least two sheets of drywall, the trim strip assembly comprising:
a trim strip body extending along a body axis and having at least one inside surface and at least one outside surface; and
an adhesive layer formed over at least a portion of the at least one inside surface of the trim strip body, the adhesive layer having a softening point temperature range such that when the adhesive layer is heated to a temperature within the softening point temperature range, the adhesive layer bonds to at least one of the at least two sheets of drywall to secure the trim strip body to the at least one of the at least two sheets of drywall.

2. The trim strip assembly of claim 1, wherein the softening point temperature range is defined by temperatures that are less than temperatures defining a melting point temperature range of the trim strip body.

3. The trim strip assembly of claim 1, wherein the softening point temperature range is between approximately 125° F. and approximately 225° F.

4. The trim strip assembly of claim 1, wherein the melting point temperature range of the trim strip body is between approximately 250° F. and approximately 450° F.

5. The trim strip assembly of claim 1, wherein the at least one inside surface includes an inside surface of a first side wall of the trim strip body and an inside surface of a second side wall of the trim strop body.

6. The trim strip assembly of claim 5, wherein the first side wall and the second side wall may form a V-shaped cross-section when viewed along the body axis.

7. The trim strip assembly of claim 1, further comprising:
a backing paper, wherein a portion of the backing paper is secured to the at least one outside surface of the trim strip body.

8. The trim strip assembly of claim 1, wherein the adhesive layer is a heat-activated hot melt adhesive.

9. The trim strip assembly of claim 1, wherein the trim strip body comprises at least one of:
(a) a polymer material;
(b) a metal material; and
(c) a heavy paper material.

10. The trim strip assembly of claim 1, wherein the trim strip body comprises a flexible paper material.

11. An application tool for securing a formable trim strip on a corner of at least two sheets of drywall, the formable trim strip including a trim strip body having a first side wall and a second side wall and a heat activated adhesive layer formed over at least a portion of an inside surface of the first side wall and an inside surface of the second side wall, the application tool comprising:
a base member having a first base wall and a second base wall, the first base wall having an inside surface and an outside surface and the second base wall having an inside surface and an outside surface, the base member extending parallel to a base axis from a first end to a second end;
a first heating member coupled to the inside surface of the first base wall of the base member;
a second heating member coupled to the inside surface of the second base wall of the base member;
wherein when the application tool is positioned along the formable trim strip such that an outer surface of the first heating member is disposed in contact with or adjacent to a portion of the outside surface of the first side wall of the trim strip body and an outer surface of the second heating member is disposed in contact with or adjacent to a portion of the outside surface of the second side wall of the trim strip body, (a) heat generated by the first heating member is transferred through the first side wall of the trim strip body to activate the heat activated adhesive layer disposed on the inside surface of the first side wall to bond the first side wall of the trim strip body to a first sheet of the at least two sheets of drywall and (b) heat generated by the second heating member is transferred through the second side wall of the trim strip body to activate the heat activated adhesive layer disposed on the inside surface of the second side wall to bond the second side wall of the trim strip body to a second sheet of the at least two sheets of drywall.

12. The application tool of claim 11, wherein the first base wall and the second base wall cooperate to form a V-shaped cross-section when viewed along the base axis.

13. The application tool of claim 11, further comprising:
a joint coupled to the base member; and
a handle coupled to the joint such that the handle is coupled to the base member.

14. The application tool of claim 13, wherein the joint is a ball and socket joint that rotatably couples the handle to the base member.

15. The application tool of claim 11, wherein a first end of the first heating member is disposed adjacent to the first end of the base member and a second end of the first heating member is disposed adjacent to the second end of the base member, and
a first end of the second heating member is disposed adjacent to the first end of the base member and a second end of the second heating member is disposed adjacent to the second end of the base member.

16. The application tool of claim 11, wherein
the first heating member is displaceably coupled to the inside surface of the first heating member by at least one resilient member, and
the second heating member is displaceably coupled to the inside surface of the second side wall by at least one resilient member.

17. A method of securing a formable trim strip on a corner of at least two sheets of drywall using an application tool, the formable trim strip assembly including a trim strip body having a first side wall and a second side wall and a heat activated adhesive layer formed over at least a portion of an inside surface of the first side wall and an inside surface of the second side wall, the application tool including a base member having a first base wall and a second base wall, the first base wall having an inside surface and an outside surface and the second base wall having an inside surface and an outside surface, the base member extending parallel to a base axis from a first end to a second end, a first heating member coupled to the inside surface of the first base wall of the base member, and a second heating member coupled to the inside surface of the second base wall of the base member, the method comprising;
positioning the application tool along the formable trim strip such that an outer surface of the first heating member is disposed in contact with or adjacent to a portion of the outside surface of the first side wall of the trim strip body and an outer surface of the second heating member is disposed in contact with or adjacent to a portion of the outside surface of the second side wall of the trim strip body;
using the first heating member, generating and transferring heat through the first side wall of the trim strip body to activate the heat activated adhesive layer disposed on the inside surface of the first side wall;
bonding the first side wall of the trim strip body to a first sheet of the at least two sheets of drywall;
using the second heating member, generating and transferring heat through the second side wall of the trim strip body to activate the heat activated adhesive layer disposed on the inside surface of the second side wall;
bonding the second side wall of the trim strip body to a second sheet of the at least two sheets of drywall.

18. The method of claim 17, further comprising applying pressure on the trim strip body to facilitate bonding the first side wall of the trim strip body to the first sheet and the second side wall of the trim strip body the second sheet.
